(19) United States
(12) Patent Application Publication
(10) Pub. No.: US 2022/0142192 A1
(43) Pub. Date: May 12, 2022

(54) OIL-IN-WATER EMULSIFIED FOOD COMPOSITION WITH HIGH OLEIC OIL

(71) Applicant: Conopco Inc., d/b/a UNILEVER, Englewood Cliffs, NJ (US)

(72) Inventors: Christiaan Michaël Beindorff, Wageningen (NL); Alessia Ermacora, Wageningen (NL); Sabrina Silva Paes, Wageningen (NL)

(73) Assignee: Conopco Inc., d/b/a UNILEVER, Englewood Cliffs, NJ (US)

(21) Appl. No.: 17/601,935

(22) PCT Filed: Mar. 30, 2020
(86) PCT No.: PCT/EP2020/058965

§ 371 Date: Oct. 7, 2021

(30) Foreign Application Priority Data
Apr. 12, 2019 (EP) 19168966.0

(51) Int. Cl. A23D 7/005; A23D 7/02; A23L 27/60

(52) U.S. Cl. CPC A23D 7/0053; A23V 2002/00; A23L 27/60; A23D 7/02

(57) ABSTRACT

The present invention relates to an oil-in-water-emulsified food product comprising:
Vegetable oil, comprising C18:1 and C18:2 fatty acids, in an amount, based on the weight of the vegetable oil, of:
   C18:1 from 35 to 95 wt %,
   C18:2 from 1 to 50 wt %,
Water,
extract of Morus alba.

### FIELD OF THE INVENTION

The present invention relates to an oil in water emulsified food composition comprising high oleic oil and a process for manufacturing the same. It further relates to the use of extract of Morus to reduce the off-flavor formation in an oil-in-water emulsified food composition comprising high oleic oil.

### BACKGROUND OF THE INVENTION

Oil-in-water emulsions, such as mayonnaise, are prone to oxidation of the oil component. Especially in compositions with a relatively high oil level, the effects of such oil oxidation become more pronounced and may involve change in color and rancidity taste. A means to counter this development is the addition of ethylenediaminetetraacetic acid (EDTA).

EDTA is considered an undesired ingredient in food compositions, as it can be perceived by some consumers as an unnatural or unhealthy chemical. There is a desire to omit EDTA from food compositions such as mayonnaise, while maintaining the fresh taste character. For example, EP3459365A1 relates to a composition comprising water and vegetable oil and a defined apple cider vinegar to reduce oxidation.

When oils with a higher oleic acid fraction, i.e. which comprise a relatively higher level of oleic acid compared to the normal oil variant, an increased oil oxidative stability is achieved, as for example observed by the reduced oxygen consumption overtime, which can be even comparable to when EDTA was used. The use of these oils comprising a high oleic acid fraction is however attended with a specific problem of its own. After a short period of storage, normally less than a month, a specific unpleasant off-taste is developed, which significantly reduced the acceptance of the oil-in-water emulsified food composition.

Emulsified products comprising a high level of oil containing high oleic fatty acids (high oleic oils) are known. The off taste is taken for granted or masked by flavor additions.

### SUMMARY OF THE INVENTION

A need remains for an oil-in-water emulsion that is stable against oxidation while not relying on EDTA, and wherein no off-taste is developed during storage, at least wherein the off taste is reduced.

Surprisingly, this challenge was met by an oil-in-water emulsified food composition comprising:
Water,
Vegetable oil, comprising C18:1 and C18:2 fatty acids in an amount, based on the weight of the vegetable oil, of:
   C18:1 from 35 to 95 wt %, preferably from 40 to 90 wt %,
   C18:2 from 1 to 50 wt %, preferably of from 5 to 45 wt %,
Extract of Morus alba.

In a further aspect, the invention relates to a method to produce the composition of the invention, the method comprising the steps of:
a. Providing a water phase comprising water,
b. Providing an oil phase comprising vegetable oil comprising C18:1 and C18:2 fatty acids, in an amount, based on the weight of the vegetable oil, of:
   C18:1 from 35 to 95 wt %, preferably from 40 to 90 wt %,
   C18:2 from 1 to 50 wt %, preferably of from 5 to 45 wt %, wherein the water phase, the oil phase or both further comprise extract of Morus alba,
c. Mixing the oil phase and the water phase to provide an emulsified food product.

In a further aspect, the invention relates to the use of extract of Morus alba in an amount of from 0.01 to 2 wt %, preferably of from 0.02 to 1.5 wt %, more preferably of from 0.05 to 1, even more preferably of from 0.1 to 0.5 wt % to reduce off-taste in an oil-in-water emulsified food composition, preferably a mayonnaise, salad dressing or vinaigrette, the emulsion comprising vegetable oil, and water, wherein the vegetable oil comprises C18:1 and C18:2 fatty acids, in an amount, based on the weight of the vegetable oil, of:
C18:1 from 35 to 95 wt %, preferably from 40 to 90 wt %,
C18:2 from 1 to 50 wt %, preferably of from 5 to 45 wt %.

### DETAILED DESCRIPTION OF THE INVENTION

All percentages, unless otherwise stated, refer to the percentage by weight (wt %).

“Weight ratio” means that the concentration of a first (class of) compound(s) is divided by the concentration of a second (class of) compound(s), and multiplied by 100 in order to arrive at a percentage.

“Spoonable” means that a composition is semi-solid but not free-flowing on a time scale typical for eating a meal, meaning not free-flowing within a time period of an hour. A sample of such substance is able to be dipped with a spoon from a container containing the composition.

Except in the operating and comparative examples, or where otherwise explicitly indicated, all numbers in this description indicating amounts or ratios of material or conditions of reaction, physical properties of materials and/or use are to be understood as modified by the word “about”.

Features described in the context of one aspect of the invention can be applied in another aspect of the invention.

The invention provides a food product as defined in the first aspect above.

Emulsion

The composition of the invention is in the form of an oil-in-water emulsion. Examples of oil-in-water emulsions encompassed by the present invention include emulsified sauces, such as mayonnaise, and dressings, such as salad dressings and vinaigrettes. Preferably, the food composition is an emulsified sauce or dressing, preferably a mayonnaise or salad dressing and most preferably is a mayonnaise. Generally, a mayonnaise is spoonable, while a salad dressing is pourable.

In the context of the present invention, the preferred oil-in-water emulsion may be stable as an emulsion during a time period of for example less than one hour (like for example some vinaigrettes). It is preferred that (after emulsifying) the emulsion is stable for more than one hour, preferably during a time period of half a year or more (like for example some mayonnaises).

Mayonnaise is generally known as a thick, creamy sauce that can be used as a condiment with other foods. Mayonnaise is a stable water-continuous emulsion of typically vegetable oil, egg yolk and either vinegar or lemon juice. In many countries the term mayonnaise may only be used in case the emulsion conforms to the “standard of identity”, which defines the composition of a mayonnaise. For example, the standard of identity may define a minimum oil level, and a minimum egg yolk amount. Also, mayonnaise-like products having oil levels lower than defined in a standard of identity or not containing egg yolk can be considered to be mayonnaises in the context of the present invention. This kind of products may contain thickeners like starch to stabilise the aqueous phase. Mayonnaises may vary in colour, and are generally white, cream-coloured, or pale yellow. The texture may range from light creamy to thick. Generally, mayonnaise is spoonable. In the context of the present invention “mayonnaise” includes such mayonnaise and ‘mayonnaise-like’ emulsions with vegetable oil levels ranging from 5% to 85% by weight of the product. Mayonnaises in the context of the present invention do not necessarily need to conform to a standard of identity in any country.

Oil

The term “oil” as used herein refers to lipids selected from triglycerides, diglycerides, monoglycerides and combinations thereof. The term “vegetable oil” is not limited to one specific oil, but can comprise one or more specific oils. Preferably the oil in the context of this invention, the vegetable oil, comprises at least 90 wt % of triglycerides, more preferably at least 95 wt %. Preferably the oil contains less than 20 wt % of solid fat at 5° C., preferably less than 10 wt % solid fat. More preferred the oil is free from solid fat at 5° C. Most preferred the oil is liquid at 5° C. Preferred oils for use in the context of this invention are vegetable oils which are liquid at 5° C. In the context of this invention, algae oil is considered a vegetable oil. Preferably the vegetable oil comprises sunflower oil, rapeseed oil, soybean oil, algae oil, and combinations of these oils. Most preferably, the vegetable oil is selected from soybean oil, sunflower seed oil, rape seed oil and mixtures thereof. Therefore, preferably the vegetable oil is an edible oil. The oil preferably comprises monounsaturated and/or polyunsaturated fatty acids. The monounsaturated fatty acids as comprised in the oil preferably comprise oleic acid. The polyunsaturated fatty acids as comprised in the oil preferably comprise linoleic acid and linolenic acid.

The amount of saturated fatty acids could preferably be from 2 to 15 wt %, more preferably of from 3 to 12 wt %, even more preferably of from 5 to 11 wt % based on the total weight of the vegetable oil. It can be preferred to be less than 15 wt %, more preferably less than 12 wt %, even more preferably less than 11 wt %, even more preferably less than 10 wt %, based on the total weight of the vegetable oil. The amount could be preferably more than 2 wt %, more preferably more than 3 wt %, even more preferably more than 5 wt %, based on the total weight of the vegetable oil.

Preferably the amount of olive oil in the composition of the invention is maximally 40% by weight of the composition. More preferably the amount of olive oil in the composition of the invention is maximally 20% by weight of the composition, more preferred maximally 15% by weight of the composition. Preferably the amount of olive oil in the composition of the invention is maximally 20% by weight of the composition, more preferred maximally 15% by weight of the composition more preferred maximally 10% by weight of the composition. It may be preferred, that the vegetable oil does not comprise olive oil.

Preferably the concentration of vegetable oil ranges from 5 to 85 wt %, preferably from 10% to 80% by weight, more preferably of from 10 to 78 wt %, even more preferably of from 15 to 75 wt %, even more preferably 25 to 70 wt %, based on the weight of the composition. Preferably the amount of vegetable oil is at least 5 wt %, more preferably at least 15% by weight, preferably at least 25% by weight. Preferably the concentration of vegetable oil is maximally 80 wt %, more preferably at most 78 wt % even more preferably at most 75% by weight, preferably maximally 70% by weight. Any combination of ranges using these mentioned end points are considered to be part of the invention as well.

High Oleic Oil

In the context of the present invention, vegetable oil is used which comprises fatty acids with one (C18:1) unsaturated carbon atom and fatty acids with two (C18:2) unsaturated carbon atoms. It is preferred that fatty acids are present with three (018:3) unsaturated carbon atoms. C18:1 and C18:2 fatty acids are present in the following amounts, based on the weight of the total amount of vegetable oil:
C18:1 from 35 to 95 wt %, preferably from 40 to 90 wt %,
C18:2 from 1 to 50 wt %, preferably of from 5 to 45 wt %.

If C18:3 fatty acids are present, they are present in an amount, based on the weight of the total amount of vegetable oil, of preferably less than 9 wt %, more preferably less than 8 wt %, even more preferably less than 7 wt %, even more preferably less than 6 wt %, even more preferably less than 5 wt %, based on the weight of the vegetable oil. It is preferred that the C18:3 fatty acid is present in an amount of more than 0.05 wt %, more preferably of more than 0.1 wt %, even more preferably of more than 0.2 wt %, even more preferably more than 0.5 wt %, and still even more preferably of more than 1 wt %, based on the weight of the vegetable oil. Preferably C18:3 fatty acid is present in an amount of from 0 to 9 wt %, preferably of from 0.05 to 8 wt %, even more preferably of from 0.1 to 7 wt %, even more preferably of from 0.2 to 6 wt %, even more preferably of from 0.5 to 5 wt %, based on the weight of the vegetable oil.

The total amount of mono-, di- and tri-unsaturated C18 fatty acid (i.e. C18:1, C18:2 and 18:3) is preferably from 75 to 96 wt %, more preferably of from 80 to 95 wt %, even more preferably of from 85 to 93 wt % based on the total weight of the vegetable oil.

It is preferred, that the total vegetable oil in the composition according to the invention comprises from 1 to 50 wt %, more preferably of from 5 to 48 wt %, even more preferably of from 7 to 45 wt % C18:2 and C18:3 (combined), based on the total weight of the vegetable oil.

The total vegetable oil in the composition comprises C18:1 fatty acids which are preferably present in an amount of more than 35 wt %, more preferably more than 45 wt %, even more preferably more than 50 wt %, even more preferably more than 60 wt %. The total oil in the composition of the invention preferably comprises less than 95 wt %, more preferably less than 90 wt %, even more preferably less than 85 wt %, even more preferably less than 80 wt %, even more preferably less than 75 wt % of C18:1 fatty acid, based on the weight of the vegetable oil. C18:1 fatty acid is preferably present in an amount of from 35 to 95 wt %, preferably 40 to 90 wt %, most preferably 45 wt % to 85 wt %, or even 50 to 75 wt %, based on the weight of the vegetable oil.

The total vegetable oil in the composition comprises C18:2, which is preferably present in an amount of from 1 wt % to 50 wt %, preferably from 5 to 45 wt %, based on the weight of the vegetable oil.

It may be preferred that the composition comprises C18:1 in an amount of from 40 to 90 wt % and C18:2 fatty acid in an amount of from 5 to 45 wt %, based on the weight of the vegetable oil. It may be preferred that the composition comprises C18:1 in an amount of from 40 to 90 wt % and C18:2 fatty acid in an amount of from 5 to 45 wt %, and 018:3 in an amount of 0.05 to 8 wt %, based on the weight of the vegetable oil.

The vegetable oil in the invention may be a high oleic oil or may comprise high oleic oil.

High oleic oil is defined as oil with a very high content of oleic acid (018:1). Oleic acid is a monounsaturated omega-9 fatty acid. It is preferred that the vegetable oil contains more than 70 wt % of oleic acid in its fatty acid composition, preferably more than 75 wt %. It is preferred, that the vegetable oil comprises a high oleic oil, defined as an oil wherein the fatty acid composition comprises more than 70 wt % of oleic acid, based on the weight of the high oleic oil. Not all vegetable oil needs to be a high oleic oil. It may be preferred, that the vegetable oil further comprises oil which is not a high oleic oil. High oleic oil is preferably present in the composition of the invention in an amount of from 20 wt % to 100 wt %, preferably of from 20 to 80 wt %, more preferably of from 50 to 80 wt % based on the weight of the total vegetable oil in the composition. High oleic oil is preferably present in an amount of more than 25 wt % based, more preferably more than 40 wt % on the weight of the composition.

Such a high oleic oil preferably is high oleic sunflower oil, high oleic rapeseed oil, high oleic soybean oil, high oleic algae oil, or a mixture thereof.

Water

The composition of the invention comprises water. The total amount of water is preferably of from 15 to 95 wt %, preferably of from 17 to 90 wt %. It can be preferred that water is present in an amount of from 20 to 85 wt %, preferably in an amount of from 22 to 80 wt %. Preferably the amount of water is at least 15 wt %, more preferably at least 17% by weight, even more preferably at least 20%, more preferably at least 22 wt %, even more preferably at least 40 wt % or even 55 wt % by weight. Preferably the concentration of water is maximally 95 wt %, more preferably at most 90 wt %, even more preferably at most 85 wt % more preferably at most 80 wt % even more preferably at most more 75 wt %. Any combination of ranges using these mentioned end points are considered to be part of the invention as well.

Emulsifier

Preferably the composition of the invention comprises an oil-in-water emulsifier. The emulsifier serves to disperse oil droplets in the continuous aqueous phase of an oil-in-water emulsion. Preferably the emulsifier comprises an oil-in-water emulsifier originating from egg, preferably from egg yolk. Preferably the composition comprises egg yolk. This suitably serves as an ingredient which also provides the oil-in-water emulsifier. The presence of egg yolk may be beneficial for taste, emulsification and/or stability of the oil droplets in the composition of the invention. Egg yolk contains phospholipids, which act as emulsifier for the oil droplets.

Preferably the concentration of egg yolk in the composition of the invention ranges from 1% to 10% by weight of the composition, more preferred from 2% to 8% by weight of the composition, even more preferably from 2.5% to 6% by weight of the composition. The egg yolk may be added as egg yolk component, meaning largely without egg white. Alternatively, the composition may also contain whole egg, containing both egg white and egg yolk. The total amount of egg yolk in the composition of the invention includes egg yolk that may be present as part of whole egg. Preferably the concentration of phospholipids originating from egg yolk ranges from 0.08% to 0.8% by weight, preferably from 0.2% to 0.5% by weight of the food product.

Alternatively, or in addition to the egg-derived emulsifier, the composition of the invention may comprise an oil-in-water emulsifier that does not originate from egg or egg yolk. Preferably such oil-in-water emulsifier is from plant or botanical origin, and may be used native or modified. This way a vegan oil-in-water emulsifier can be created without ingredients from animal origin. Preferably the oil-in-water emulsifier comprises starch sodium octenyl succinate (European food additive E1450). This emulsifier is available commercially as for example N-creamer 46, ex Ingredion Inc. (Westchester, Ill., USA). Another preferred emulsifier from botanical origin is legume protein.

Acid and pH

The composition of the invention preferably has a pH ranging from 2.5 to 5, preferably ranging from 2.5 to 4.

The composition preferably comprises an acid. Preferably the acid comprises organic acid. More preferably, the acid is organic acid. Preferably, the organic acid comprises an acid selected from the group consisting of acetic acid, citric acid, malic acid, lactic acid, succinic acid, formic acid, propionic acid, ascorbic acid, salts thereof and mixtures thereof. Preferably the acid is selected from the group consisting of acetic acid, citric acid, malic acid, lactic acid, succinic acid, salts thereof and mixtures thereof. It is more preferred that the composition comprises acetic acid and salts thereof. Preferably the composition of the invention has a total titratable acidity ranging from 0.03% to 3% by weight expressed as acetic acid, preferably from 0.05% to 2% by weight, preferably from 0.1% to 1% by weight. Acetic acid is preferably present in an amount of more than 50 wt %, more preferably more than 80 wt %, even more preferably more than 90 wt %, even more preferably more than 95 wt % based on the weight of the total amount of acid in the composition.

It can be preferred that the composition comprises acetic acid and one or more acids selected from the group consisting of citric acid, malic acid, lactic acid, succinic acid and mixtures thereof.

The acids as described in this specification include their corresponding salts which are in equilibrium with the acids (acetates, citrates, malates, lactates, succinates, etc.). In case a concentration of an acid is provided, then this concentration refers to total concentration of the acid and its corresponding salt.

Mulberry Extract

The oil-in-water emulsified food composition of the present invention comprises Morus alba extract, preferably in an amount of from 0.01 to 2%, more preferably comprises from 0.02 to 1.5%, more preferably comprises from 0.05 to 1%, even more preferably from 0.07 to 0.7%, even more preferably of from 0.1 to 0.5%, expressed as dry weight of the extract based on the weight of the emulsified food composition. The term ‘Morus alba extract’ as used herein refers to a composition that has been isolated from Morus alba extract fruit, leave or root. Typically, the Morus alba extract does not contain insoluble parts such as seeds or peel. Mulberry extract, and in particular Morus alba extract, is defined as the extract as such. For example, without additional processing aids such as for example maltodextrins or sugars.

Mulberry, Morus, is a genus of flowering plants in the family Moraceae, and comprises ten to sixteen species of deciduous trees commonly known as mulberries, growing wild and under cultivation in many temperate world regions. The following species are accepted by the Kew Plant List as of August 2015: Morus alba L., Morus australis Poir., Morus cathayana Hemsl., Morus celtidifolia Kunth, Morus indica-L., Morus insignis, Morus japonica Audib., Morus liboensis S. S. Chang, Morus macroura Miq., Morus mesozygia Stapf, Morus mongolica (Bureau) C. K. Schneid., Morus nigra L., Morus notabilis C. K. Schneid., Morus rubra L., Morus serrata Roxb., Morus trilobata (S. S. Chang), Morus wittiorum Hand.-Mazz.

The mulberry extract in the emulsified food composition of the invention (the Morus alba extract) is preferably selected from extract of fruit, leaves, root and combinations thereof, preferably the Morus alba extract is Morus alba fruit extract. Morus alba extract is preferably applied in dried form, more preferably in dried, ground form. The Morus alba extract that is employed in accordance with the present invention can be a solid product, a paste or a liquid. Preferably, the Morus alba extract is a dry solid product, preferably a powder.

In the present invention, the preferred Morus alba extract is a Morus alba fruit extract. It may be preferred that the extract is an aqueous Morus alba fruit extract, more preferably the extract is a dried extract obtained from an aqueous Morus alba fruit extract.

Preferably at least 80 wt. % of the dry matter of the Morus alba extract, preferably obtained from an aqueous Morus alba extract, preferably of a Morus alba fruit extract, dissolves when the material is added to demineralized water at a temperature of 20° C. in a concentration providing 20 gram of dry matter per litre. The Morus alba extract is preferably a dried aqueous extract of mulberry fruit.

Preferably, the Morus alba extract has a water content of less than 15 wt. %, more preferably of less than 10 wt. % and most preferably of less than 8 wt. %.

A dried mulberry extract, preferably a mulberry fruit extract, obtained from an aqueous mulberry extract, or mulberry fruit extract respectively, which can be used in accordance with the present invention, may suitably be obtained as follows: dried mulberry fruit, root or leave, preferably fruit, is sliced, extracted with water, filtered and concentrated, and finally dried (e.g. by spray-drying) into fine powder. No excipient needs to be used during such spray-drying process, resulting in a final product with a dried mulberry material to dried extract ratio of e.g. 10:1.

The mulberry extract that is employed in accordance with the present invention preferably has the following dry matter composition:
10-40 wt. % amino acids (including amino acid residues contained in peptides and proteins);
7-28 wt. % organic compounds with an acidic function other than amino acids;
11-44 wt. % carbohydrates.

To this end, the composition of the invention preferably contains DNA and/or RNA of Morus alba.

In the composition of the invention the mulberry extract is preferably dissolved in the water.

The total amount of polyphenols in the mulberry extract is preferably more than 0.6 GAE % (“gallic acid equivalents”), more preferably more than 1 GAE %, based on the dry weight of the mulberry extract. Preferably, from 0.6 GAE % to 15 GAE %, more preferably from 1 to 15 GAE %, more preferably from 0.6 to 10 GAE %, even more preferably of from 0.6 to 6 GAE %, more preferably from 1.5 to 6 GAE %, even more preferably of from 2 to 4 GAE %. A common method to determine the phenolic compounds concentration of a sample, is the concentration in “gallic acid equivalents” (GAE). Whenever reference is made herein to “gallic acid equivalents” what is meant is the amount of gallic acid equivalents as determined by the Folin-Ciocalteu assay, as known in the art. Gallic acid (3,4,5-trihydroxybenzoic acid) is the phenolic acid that is used as a standard for determining the phenol content of various analyses by the Folin-Ciocalteu assay (see V. L. Singleton et al., Analysis of total phenols and other oxidation substrates and antioxidants by means of Folin-Ciocalteu reagent, Methods in Enzymology 299, 152-178, 1999).

The mulberry extract as used in the composition of the invention preferably comprises total free amino acids in an amount of more than 3 mg/g, based on the dry weight of the extract. Preferably from 3 to 150 mg/g, even more preferably of from 50 to 120 mg/g, even more preferably of from 70 to 100 mg/g, even more preferably of from 80 to 100 mg/g, based on the dry weight of the extract.

The mulberry extract as used in the composition of the invention preferably comprises organic acids in a total amount of from 17 to 200 mg/g, preferably of from 40 to 200 mg/g, preferably from 80 to 180, even more preferably of from 120 to 160 mg/g based on the dry weight of the extract. Organic acid is understood here as acetic acid, citric acid, malic acid, lactic acid, succinic acid, formic acid, propionic acid, ascorbic acid, salts thereof, and mixtures thereof. It is particularly preferred, when the extract of Morus alba comprises organic acids in a total amount of from 17 to 200 mg/g, preferably of from 40 to 200 mg/g, preferably from 80 to 180, even more preferably of from 120 to 160 mg/g based on the dry weight of the extract and from 0.6 to 15 GAE %, more preferably from 1 to 15 GAE %, even more preferably from 0.6 to 10 GAE %, even more preferably of from 0.6 to 6 GAE %, more preferably of from 1.5 to 6 GAE %, even more preferably of from 2 to 4 GAE %, based on the dry weight of the Morus alba extract.

The mulberry extract as used in the composition of the invention preferably comprises citric acid and salts thereof in an amount of more than 20 wt %, based on the weight of total organic acids in the extract. A most preferred amount is from 65 to 85 wt % based on the weight of total organic acids in the extract. Organic acid is understood here as acetic acid, citric acid, malic acid, lactic acid, succinic acid, formic acid, propionic acid, ascorbic acid, salts thereof and mixtures thereof.

The mulberry extract as used in the composition of the invention preferably comprises from 1 to 100, preferably from 40 to 60 mg/g of quinic acid and salts thereof, based on the dry weight of the Morus alba extract.

Amounts of total amino acids, organic acids, citric and quinic acid can for example be determined by NMR analysis, as known in the art, and specified in the example section herein.

Color variations are not appreciated by some consumers. It is a preference, and a preferred advantage of the invention, that the food composition has a color that is not too different from the color of the product without mulberry extract. Color can be measured as known in the art according to a CIE L*a*b* scale. In particular, compositions are preferred having a L*a*b* color value of the Morus alba extract, measured at 0.1% of the extract in water, wherein the L* value of a 0.1 wt % aqueous solution of the extract is higher than 80, preferably from 80 to 92, more preferably is from 88 to 90. The b* value is preferably more than 1, preferably of between 1 and 30, even more preferably of between 2 and 20, most preferably of between 4 and 12. Such L* values and b* values, preferably the combination of such L* and b* values of the extract provide food compositions according to the invention, especially mayonnaise compositions, which most resemble, with respect to color, the food compositions without the Morus alba extract.

L* for mayonnaise compositions according to the invention is preferably of from 50 to 95, preferably of from 70 to 95, even more preferably of from 80 to 92, most preferably of from 85 to 92. The difference in color ΔE between the colour of a composition with and without the Morus alba extract is calculated as follows ΔE*=SQRT(ΔL*²+Δa*²+Δb*²). The difference in color ΔE between a composition with and without the Morus alba extract, calculated as ΔE*=SQRT(ΔL*²+Δa*²+Δb*²) is preferably of from 0 to 30, more preferably of from 0 to 20, even more preferably of from 0 to 10 and most preferably of from 0 to 5. These maximum differences in color ΔE are especially desired and preferred if the product is a mayonnaise or a salad dressing, but are not limited to these types of food product.

Hence, preferably the Morus alba extract comprises
total polyphenols in an amount of from 0.6 to 15 GAE %, preferably of from 1 to 15 GAE %, even more preferably of from 1 to 10 GAE %, even more preferably of from 1.5 to 6 GAE %, most preferably of from 2 to 4 GAE %, based on the dry weight of the Morus alba extract
total free amino acids in an amount of from 3 to 150 mg/g, even more preferably of from 50 to 120 mg/g, even more preferably of from 70 to 100 mg/g, even more preferably of from 80 to 100 mg/g, based on the dry weight of the Morus alba extract.
total organic acids in an amount of from 17 to 200 mg/g, preferably of from 40 to 200 mg/g, preferably of from 80 to 180 mg/g more preferably of from 120 to 160 mg/g, based on the dry weight of the Morus alba extract, wherein organic acid is understood here as acetic acid, citric acid, malic acid, lactic acid, succinic acid, formic acid propionic acid, ascorbic acid, salts thereof and mixtures thereof, and
wherein the Morus alba extract has an L*a*b* value when measured in a 0.1 wt % aqueous solution wherein the L* value is higher than 80, preferably from 80 to 92, more preferably is from 88 to 90 and the b* value is preferably more than 1, preferably of between 1 and 30, even more preferably of between 4 and 12. In this extract it is preferred that quinic acid is present in an amount of from 1 to 100, preferably from 40 to 60 mg/g and salts thereof based on the dry weight of the Morus alba extract.

Other Ingredients

The composition of the invention preferably contains additionally other ingredients than already specifically mentioned in here. Preferably the composition contains plant material in the form of herbs and/or spices. In case such ingredients are present in the composition, then generally their total concentration is at least 0.1% by weight, and preferably maximally 10% by weight, preferably maximally 5% by weight.

The composition of the invention may comprise sugar, but high levels are not desired. Sugar may be present to an amount of from 0.1 to 15 wt %, preferably of from 0.3 to 12 wt %, even more preferably of from 0.4 to 10 wt %, most preferably of from 0.5 to 8 wt %, based on the weight of the composition.

Total alkaline metal salt, for example sodium chloride, may be present to an extent of from 0.1 to 5 wt %, preferably from 0.15 to 4 wt %, or more preferably of from 0.2 to 3 wt %, based on the weight of the composition.

The food composition of the invention may comprise a thickener. It may be preferred that the food composition comprises a thickener such as a hydrocolloid thickener. Therefore, the food composition may preferably comprise starch or gum or mixtures thereof. A preferred gum is xanthan gum. The composition may comprise starch in an amount of from 0.1 to 8 wt %, preferably of from 0.2 to 7 wt %, more preferably of from 0.5 to 6 wt %, or even from 0.5 to 5 wt % can be preferred, based on the weight of the food product. It is preferred, that when starch is present, or gum, the oil content is between 5 and 72 wt %, preferably of between 8 and 70 wt %, preferably of between 10 and 60 wt % based on the weight of the food product.

The amount of EDTA which commonly is present in compositions containing vegetable oil can be strongly reduced. Hence, preferably the composition comprises EDTA at a concentration lower than 0.008 wt %, preferably from 0 to 0.007% by weight, preferably lower than 0.005% by weight, preferably from 0 to 0.005 wt %, preferably lower than 0.002% by weight, preferably from 0 to 0.002 wt % preferably lower than 0.001% by weight, preferably from 0 to 0.001 wt % of the composition. Most preferred EDTA is absent from the composition.

Method for Preparation of Composition

The compositions of the invention are prepared by any method commonly known for preparing oil-in-water emulsions. Preferably, by using such method, an oil-in-water emulsion is prepared, wherein the oil droplets have a surface weighted mean diameter D3,3 of less than 10 micrometer (see M. Alderliesten, Particle & Particle Systems Characterization 8 (1991) 237-241; for definitions of average diameters).

Accordingly, in a second aspect the present invention provides a method for making an emulsified food composition according to the first aspect of the invention. Preferred compounds and amounts indicated in the first aspect of the invention apply for this aspect as well. The method comprises the steps of:
a. Providing a water phase comprising water,
b. Providing an oil phase comprising vegetable oil comprising C18:1 and C18:2 oleic acids, in an amount, based on the weight of the total vegetable oil, of:
   C18:1 from 35 to 95 wt %, preferably from 40 to 90 wt %,
   C18:2 from 1 to 50 wt %, preferably of from 5 to 45 wt %,
wherein the water phase, the oil phase or both further comprise extract of Morus alba,
c. Mixing the oil and the water phase to provide an emulsified food composition.

The method of the invention comprising mixing, preferably homogenisation, of a mixture of oil and water. This results in an oil-in-water emulsion. Technology to prepare oil-in-water emulsions is known in the art, e.g. for mayonnaise making. Preferably, water and water-soluble ingredients are provided in step a). Acid can be pre-added to the water in step a).

Acid can be added as such or, preferably, in the form of vinegar. The water in the composition encompasses the water present in the vinegar, as the amount of water refers to the total water content of the resulting composition. Vinegar is preferably added, and preferably present in the composition, in an amount of from 1 to 20 wt %, based on the weight of the composition.

The mulberry (Morus alba) extract can be added to the water in step a), to the oil phase in step b) or to both the water phase and the oil phase in steps a) and b), respectively. It is preferred that the extract of Morus alba is added to the water phase is in step a). The extract of Morus alba can be pre-added to vinegar, if so desired, before adding to the water phase.

This water phase is combined with oil in step b). Oil is preferably added as high-oleic oil, as described above in relation to the food composition. The vegetable oil can comprise, or preferably, can consist of high oleic oil, as long as the total fatty acid composition of the resulting vegetable oil meets the requirements as claimed in terms of C18:1 and C18:2, and preferably, 018:3 fatty acids. The amount of high oleic oil that is preferably added is as described above in the context of the food composition, i.e. the first aspect of the invention.

The water phase comprising water, preferably mulberry extract and preferably acid, is then mixed with the oil, preferably by homogenisation or another suitable emulsification process. A colloid mill could be used to achieve this. Preferably an oil-in-water emulsion results from such mixing, e.g. by homogenisation. In the emulsion, the oil droplets preferably have a volume weighted mean droplet size D3,3 of less than 10 micrometer. The amount of Morus alba extract is as described for the composition above, and preferably ranges from 0.01 to 2 wt %, preferably 0.02 to 1.5 wt %, more preferably of from 0.05 to 1 wt %, more preferably of from 0.07 to 0.7 wt %, even more preferably of from 0.1 to 0.5 wt % (expressed as dry weight of Morus alba extract, based on weight of final resulting composition).

Extract of Morus alba is preferably added as a powder, more preferably a powder which has a moisture content of less than 15 wt. %, more preferably of less than 10 wt. % and most preferably of less than 8 wt. %. The powder is preferably dried powder, more preferably is freeze dried powder. If the powder is freeze dried, it preferably has a moisture content of less than 5 wt %.

It is preferred, when in step a) or b) an emulsifier is included, especially in case an emulsion is prepared. The emulsifier is preferably as described above in relation to the product description.

Use

In a third aspect, the present invention relates to the use of extract of Morus alba in an amount of from 0.01 to 2 wt %, preferably of from 0.02 to 1.5 wt %, more preferably of from 0.05 to 1 wt %, even more preferably of from 0.1 to 0.5 wt % to reduce off-taste in an oil-in-water emulsified food composition, preferably a mayonnaise, salad dressing or vinaigrette, the emulsion comprising vegetable oil and water, wherein the vegetable oil comprises C18:1 and C18:2 fatty acids, in an amount, based on the weight of the total vegetable oil, of:
C18:1 from 35 to 95 wt %, preferably from 45 to 90 wt %,
C18:2 from 1 to 50 wt %, preferably of from 1.5 to 45 wt %.

The invention will now be exemplified by the following, non-limiting examples:Examples:

Materials

| | |
|---|---|
| Water | Demineralized water |
| Rapeseed Oil | Rapeseed oil ex Cargill |
| | (Amsterdam, The Netherlands) |
| High Oleic | High oleic sunflower oil |
| Sunflower Oil | (C. Thywissen GmbH, Neuss, Germany) |
| Sugar | Sucrose white sugar W4 ex Suiker Unie |
| | (Oud Gastel, The Netherlands) |
| Salt | Sodium chloride Suprasel ex Akzo Nobel |
| | (Amesfoort, The Netherlands) |
| Spirit vinegar (12%) | Vinegar spirit 12% ex Kühne |
| | (Hamburg, Germany) |
| Egg yolk | Egg yolk ex Bouwhuis Enthoven |
| | (Raalte, The Netherlands); |
| | contains 92% egg yolk and 8% kitchen salt |
| Flavours | Natural flavour mix |
| Mulberry fruit | Mulberry fruit extract (Morus Alba) ex |
| extract | Draco Natural Products Inc. (California, US) |
| Lactic Acid 80% | Lactic acid (80%) PURAC FCC 80 ex |
| | Corbion, Gorinchem, the Netherlands |
| EDTA | Calcium Disodium EDTA ex |
| | Brenntag Nederland B.V., |
| | Dordrecht, the Netherlands |

Fatty acid composition of
the oils used in the examples

| | | High oleic | |
|---|---|---|---|
| | | sunflower | Rapeseed |
| | | oil | oil |
| C18:1 | % | 80.1 | 62.3 |
| C18:2 | % | 10.7 | 19.3 |
| C18:3 | % | 0.2 | 8.1 |

Samples

| | control | Mayonnaise 1 | Mayonnaise 2 | Mayonnaise 3 |
|---|---|---|---|---|
| | 100% | 100% | 100% | 100% High Oleic Oil |
| | Rapeseed | Rapeseed | High Oleic | (sunflower) + |
| | Oil + EDTA | Oil | Oil (sunflower) | mulberry extract |
| Water | 15.59 | 15.60 | 15.60 | 15.35 |
| Rapeseed Oil | 75.00 | 75.00 | 0.00 | 0.00 |
| High Oleic | 0.00 | 0.00 | 75.00 | 75.00 |
| Sunflower Oil | | | | |
| Sucrose | 1.30 | 1.30 | 1.30 | 1.30 |
| Sodium | 1.00 | 1.00 | 1.00 | 1.00 |
| chloride | | | | |
| Spirit vinegar | 2.60 | 2.60 | 2.60 | 2.60 |
| (12%) | | | | |
| Egg yolk | 4.20 | 4.20 | 4.20 | 4.20 |
| Flavours | 0.30 | 0.30 | 0.30 | 0.30 |
| Mulberry fruit | 0 | 0 | 0 | 0.25 |
| extract | | | | |
| EDTA | 0.0075 | 0 | 0 | 0 |

The pH was balanced to 3.8 with lactic acid.

### Example 1

| | Headspace oxygen content [%] | | | |
|---|---|---|---|---|
| | | | | Mayonnaise 3 |
| | | Mayonnaise 1 | Mayonnaise 2 | Invention |
| | control | Comparative | Comparative | 100% High |
| Storage time | 100% | 100% | 100% High | Oleic oil + |
| at 50° C. | Rapeseed | Rapeseed | Oleic Oil | Mulberry |
| [days] | Oil + EDTA | Oil | (sunflower) | extract |
| 0 | 21.2 | 21.1 | 21.4 | 21.8 |
| 2 | 20.9 | 19.1 | 20.5 | 21.0 |
| 5 | 20.3 | 16.9 | 19.3 | 20.4 |
| 7 | 20.5 | 16.4 | 19.2 | 20.6 |
| 9 | 20.3 | 15.9 | 19.0 | 20.3 |
| 12 | 18.9 | 14.4 | 17.9 | 19.3 |
| 14 | 18.7 | 13.9 | 17.6 | 18.8 |
| 16 | 18.7 | 13.5 | 17.6 | 19.0 |
| 20 | 17.2 | 11.7 | 16.5 | 17.8 |
| 22 | 16.9 | 11.0 | 16.4 | 17.7 |
| 27 | 16.0 | 8.0 | 15.8 | 16.9 |
| 29 | 16.0 | 6.7 | 15.9 | 16.8 |
| 33 | 15.0 | 1.3 | 14.8 | 16.2 |

The example shows the relative oxidative stability of 3 mayonnaise samples produced with rapeseed oil, high oleic oil and high oleic oil with mulberry extract, and a control mayonnaise comprising EDTA. EDTA is the standard chelating chemical commonly used in commercial mayonnaise products to prevent oil oxidation, and used in this test as positive control. The shelf life of the mayonnaise samples was evaluated under accelerated conditions (50° C.) for a period of 33 days.

The measurement of the headspace oxygen content is a well-established method to assess lipid oxidation in closed systems. In general, 1 g of sample is filled in a capped glass vial (20 mL). Oxygen content is determined by taking a sample of gas from the head space with a needle through the septum of the closed lid of the jar followed by measurement with a gas analyser. A lower oxygen content indicates a higher degree of oxidation.

After 33 days of storage, Mayonnaise 1 (where the oil phase is 100% rapeseed oil) is fully oxidized (the residual oxygen content in the headspace is below 2%). Mayonnaise 2 and 3 show a similar level of oxidation (still 14.8 and 16.2% of oxygen left in the headspace, similar to the positive control with EDTA), reflecting the relatively small sensitivity of high oleic oil for oxidation, compared to rapeseed oil.

### Example 2

| | Sensorial evaluation | | | |
|---|---|---|---|---|
| | | | | Mayonnaise 3 |
| | | Mayonnaise 1 | Mayonnaise 2 | Invention |
| | | Comparative | Comparative | 100% High |
| Storage | Control | 100% | 100% High | Oleic oil + |
| time at | (EDTA) | Rapeseed | Oleic Oil | Mulberry |
| ambient | A | Oil | (sunflower) | extract |
| 0 weeks | A | A | A | A |
| 2 weeks | A | NA | A | A |
| 4 weeks | A | NA | B | A |
| 6 weeks | A | NA | B | A |
| 8 weeks | A | NA | B | A |
| 12 weeks | A | NA | NA | A |
| 16 weeks | A | NA | NA | B |

A = Acceptable;
B = Borderline;
NA = Not Acceptable

The mayonnaise samples were evaluated sensorially by storing samples under non-accelerated conditions (ambient temperature) for a period of 16 weeks.

The overall quality of the mayonnaise samples was scored by an expert panel of 6 people as acceptable, borderline or not acceptable.

Already after 2 weeks of storage, Mayonnaise 1 (containing 100% rapeseed oil) was evaluated not acceptable by the expert panel. Mayonnaise 2 and 3, and the control with EDTA show similar high remaining levels of oxygen in the head space, i.e. relatively little oxidation, (compared to non-high oleic oil, 1.3%). Despite a similar level of oxygen in Mayonnaises 2 and 3, the taste of Mayonnaise 3 comprising the mulberry extract remains acceptable up to 16 weeks when the flavour becomes borderline (B). Without mulberry extract, the flavour becomes borderline already after 4 weeks, and after 8 weeks the taste is not acceptable anymore (mayonnaise 2).

### CONCLUSION

By the Examples it is shown, that by the use mulberry extract an acceptable mayonnaise composition could be made which shows significant oxidation reduction while showing an acceptable flavour profile (arising of off taste is significantly delayed) in shelf life time.

1. An oil-in-water emulsified food composition comprising:
Water,
Vegetable oil, comprising C18:1 and C18:2 fatty acids, in an amount, based on the weight of the vegetable oil, of:
C18:1 from 35 to 95 wt %, preferably from 40 to 90 wt %,
C18:2 from 1 to 50 wt %, preferably of from 5 to 45 wt %,
wherein the vegetable oil comprises a high oleic oil, which is defined as an oil wherein the fatty acid composition comprises more than 70 wt % of oleic acid, based on the weight of the high oleic oil,
Extract of Morus alba.

2. The composition according to claim 1, wherein the vegetable oil comprises less than 50% wt of C18:2 and C18:3 fatty acids taken together, based on the weight of the vegetable oil.

3. The composition according to claim 1, wherein the vegetable oil comprises C18:3 in an amount of from 0.01 wt % to 9 wt %, based on the weight of the vegetable oil.

4. The composition according to claim 1, wherein the vegetable oil comprises C18:1 in an amount of from 40 wt % to 90 wt %, and C18:2 is from 5 wt % to 45 wt %, based on the weight of the vegetable oil

5. The composition according to claim 1, wherein the vegetable oil is present in a total amount of from 5 wt % to 85 wt %, based on the weight of the composition.

6. The composition according to claim 1, wherein the vegetable oil comprises an oil selected from the group consisting of sunflower oil, soybean oil, rapeseed oil, algae oil and mixtures thereof.

7. (canceled)

8. The composition according to claim 1, wherein the vegetable oil further comprises oil which is not a high oleic oil, wherein high oleic oil is defined as an oil wherein the fatty acid composition comprises more than 70 wt % of oleic acid, based on the weight of the high oleic oil.

9. The composition according to claim 78, wherein the high oleic oil is present in an amount of from 20 wt % to 100 wt % based on the weight of the total vegetable oil in the composition.

10. The composition according to claim 7, wherein the high oleic oil is present in an amount of more than 25 wt % based on the weight of the composition.

11. The composition according to claim 1, wherein saturated fatty acids are present in an amount of from 2 to 15 wt %, based on the weight of the total vegetable oil.

12. The composition according to claim 1, wherein the extract of Morus alba is present in an amount of from 0.01 to 2 wt %, expressed as dry weight of extract on weight of total food composition.

13. The composition according to claim 1, wherein the extract of Morus alba comprises polyphenols in a total amount of from 0.6 to 15 gallic acid equivalents, GAE,%, preferably of 1 to 15 GAE %, based on the dry weight of the extract, and as determined by the Folin-Ciocalteu assay.

14. A process for manufacturing an oil-in-water emulsified food composition according to claim 1,
the process comprising the steps of:
a. Providing a water phase comprising water,
b. Providing an oil phase comprising vegetable oil comprising C18:1 and C18:2 fatty acids, in an amount, based on the weight of the vegetable oil, of:
C18:1 from 35 to 95 wt %, preferably from 40 to 90 wt %, C18:2 from 1 to 50 wt %, preferably of from 5 to 45 wt %,
wherein the water phase, the oil phase or both further comprise extract of Morus alba,
c. Mixing the oil and the water phase to provide an emulsified food composition.

15. A method of reducing off-taste in an oil-in-water emulsified food composition, wherein the emulsion comprises vegetable oil and water, wherein the vegetable oil comprises C18:1 and C18:2 fatty acids, in an amount, based on the weight of the vegetable oil, of:
C18:1 from 35 to 95 wt %, preferably from 40 to 90 wt %,
C18:2 from 1 to 50 wt %, preferably of from 5 to 45 wt %,
the method comprising:
providing extract of Morus alba in an amount of from 0.01 to 2 wt %.
